(19) United States
(12) Patent Application Publication
(10) Pub. No.: US 2017/0133015 A1
(43) Pub. Date: May 11, 2017

(54) METHOD AND APPARATUS FOR CONTEXT-AUGMENTED SPEECH RECOGNITION

(71) Applicants: Bernard P. TOMSA, West Bloomfield, MI (US); Michael C. VARTANIAN, Commerce Township, MI (US)

(72) Inventors: Bernard P. TOMSA, West Bloomfield, MI (US); Michael C. VARTANIAN, Commerce Township, MI (US)

(21) Appl. No.: 14/938,338

(22) Filed: Nov. 11, 2015

(51) Int. Cl. G10L 15/24; G01C 21/20; G10L 15/06; G10L 15/26; G10L 15/22

(52) U.S. Cl. CPC G10L 15/24; G10L 15/26; G10L 15/22; G10L 15/063; G01C 21/20; G10L 2015/0635; G10L 2015/0636

(57) ABSTRACT

A system includes a processor configured to receive speech-input. The processor is further configured to receive at least one location-identification. Also, the processor is configured to determine a location-related context based on the location-identification. The processor is additionally configured to access a context-related vocabulary based on the location-related context. The processor is also configured to search for word matches from the speech-input in the context-related vocabulary and provide match candidates found within the context-related vocabulary as translation of some or all of the speech-input into text.

### TECHNICAL FIELD

The illustrative embodiments generally relate to a method and apparatus for context augmented speech recognition.

### BACKGROUND

Speech recognition systems are becoming increasingly more prevalent, as users become more accustomed to talking to devices in lieu of typing. Usable while driving to obtain navigation, or in any other situation where typing may be inconvenient, almost all phones now have some form of available speech recognition. Tablets, personal computers, smart watches and other available devices all have available voice input as well. With some devices, where an interaction surface is limited or not available (e.g., smart watch, wearable smart glasses, etc.), speech recognition is almost a necessity for meaningful interaction.

A typical speech recognition system may have to draw on a possible vocabulary of hundreds of thousands, if not millions, of words. In addition to common words in the language, names of people and places add an almost infinite variety of possibilities. Because many words sound similar, and because people have a variety of accents, word recognition systems frequently return one or more wrong words when a user is attempting to utilize speech input.

The failure of speech recognition systems to properly recognize spoken input in its entirety has lead to frustration with the systems, and because of this, many users eschew the use of such systems except when absolutely necessary. Unfortunately, many of the times when such systems are used are times when a person can ill afford to check the accuracy of input, such as a request made while driving. Accordingly, users may have to stop whatever they were attempting to continue doing while using the speech input to correct errors, which generally tends to irritate users and further discourages use of such systems.

### SUMMARY

In a first illustrative embodiment, a system includes a processor configured to receive speech-input. The processor is further configured to receive at least one location-identification. Also, the processor is configured to determine a location-related context based on the location-identification. The processor is additionally configured to access a context-related vocabulary based on the location-related context. The processor is also configured to search for word matches from the speech-input in the context-related vocabulary and provide match candidates found within the context-related vocabulary as translation of some or all of the speech-input into text.

In a second illustrative embodiment, a system includes a processor configured to receive a request from a mobile device to translate speech-input into text. The processor is also configured to receive a location-identifier from the mobile device. Further, the processor is configured to determine one or more location-related contexts associated with the location-identifier, each context having a vocabulary of context-related words associated therewith. The processor is additionally configured to translate the speech-input into text. Also, the processor is configured to update usage of words in the speech-input with respect to the vocabularies of the determined location-related contexts and, if a word usage passes a predetermined threshold, based on aggregated updates to an associated usage tracking factor, based on requests from users inputting speech to be translated into text at a location associated with the location-identifier, adding the word to at least one of the vocabularies in which the word does not currently exist.

In a third illustrative embodiment, a system includes a processor configured to receive assignment of a plurality of context-identifiers associated with varied locations within a building, to the locations within the building, the locations being identifiable based on location-identifying information received in conjunction with a request to translate speech-input into text, wherein each context-identifier is associated with a vocabulary, including words related to the context-identifier. The processor is also configured to receive a request to translate speech-input into text, including the location-identifying information. The processor is additionally configured to determine one or more context-identifiers associated with a location identifiable based on the location-identifying information. The processor is also configured to utilize the vocabularies associated with the one or more context-identifiers to determine the contents of the speech-input and return the determined contents to an entity from which the request came as translated text based on the determined contents of the speech-input.

### BRIEF DESCRIPTION OF THE DRAWINGS

FIG. 1A shows an illustrative layout for several buildings;

FIG. 1B shows an illustrative floor plan of a building in FIG. 1A, including illustrative location-broadcast-device deployment;

FIG. 2 shows an illustrative tree-style list of exemplary vocabularies assemblable into a set of vocabularies for a site;

FIG. 3 shows an illustrative process for context-augmented speech recognition;

FIG. 4 shows an illustrative example of a post-search context vocabulary analysis of uncertain results;

FIG. 5 shows an illustrative process for context-related vocabulary updates;

FIG. 6 shows another illustrative process for vocabulary updates; and

FIG. 7 shows yet another illustrative process for vocabulary updates.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

Improvements in speech enhancement algorithms such as noise cancellation and acoustic echo cancellation, for example, have helped speech-recognition accuracy problems, but given the different ways people say different words (varied pronunciations, accents, etc.), “hearing” the actual sound may not be enough. Some speech recognition systems have learning capability (either real-time or a-priori), to learn the phonetic nature of a user's accent and to recognize commonly spoken words, but the user will obviously not repeat every possible word in the language a sufficient number of times to cover any possible scenario. Adding to the problem, when words are used in conjunction, as in a sentence, the user may have a tendency to blend certain words together, which can confuse speech recognition systems, because the user may enunciate a word differently when that word is used in conjunction with certain other words. For example, a user ask about possession of a truck by saying “is that y'all's truck?” (a derivative of “is that you all's truck). Speech recognition can be confused by a sentence such as this, since y'all is not technically a word, and further adding the possessive “'s” may just add to the confusion.

It is possible to use some portion of the above example sentence, i.e., “truck” as a contextual basis to determine the likely intended, but possibly confusing, word “y'all's.” Using the word “truck” alone, however, could still produce a confusing result, since UHAUL is a truck company, and UHAUL sounds very similar to y'all. Thus, the speech recognition process could use “truck” and assume that the user asked “Is that UHAUL's truck?”

While the use of sentence structure context is within the scope of the illustrative embodiments, the illustrative embodiments further propose the utilization of additional context clues to refine a possible vocabulary of terms for a given speech input. Through utilization of context, crowd-sourced information, learning algorithms, etc., the illustrative embodiments provide a system through which more accurate speech input interpretation can be changed. The concepts presented herein are done so with respect to speech recognition, but could similarly be applied to vocabulary term recognition for typed text. For example, auto correct dictionaries could be expanded and contracted based on the same concepts utilizing the context-adjusted vocabularies discussed herein.

One non-limiting way of obtaining some context about verbal input is to examine the characteristics of a location at which the input is made. While all input will not always be location-relevant, at least some portion will be, and very different vocabularies are used across a wide variety of settings. By knowing the location of a user (and through the location, characteristics associated with the location), a basis for assembling a vocabulary for use in translating speech to text can be had.

There are numerous methodologies to obtain a user location and characteristics relating to that location. Simple GNSS coordinates could be used to identify an address, for example, which could be cross-referenced with a business name or type to obtain general information about that business. This could inform a decision about which words should be searched (at least initially) in response to a verbal input translation request.

The illustrative embodiments describe a fairly intricate system for assembling, tuning and utilization of context-based vocabularies related to a user location. It is to be understood that these embodiments also encompass similar, simpler models built along the same principles, and that the degree of detail merely provides an illustrative basis for further understanding of the concepts embodied herein.

For example, one environment in which the illustrative embodiments could be practiced includes, but is not limited to, an environment whereby one or more location-identifying devices exist that are usable to determine a user location with a relative degree of accuracy. These devices, such as, but not limited to, BLUETOOTH or other beacon devices, cell-tower triangulation, Wi-Fi crowd-sourcing or dead reckoning, for example, can be used in a stand-alone configuration or in conjunction with other coordinate systems.

In a fairly specific, but intended to be non-limiting, example, a grid of BLUETOOTH beacons is deployed throughout a university campus. Each beacon identifies a location where the beacon is deployed, and can have characteristics associated therewith. For example, a back-end database can have a record of each beacon or location, and can have some set of characteristics associated with that beacon/location.

The beacons, in this example, are capable of communication with user wireless devices. By communicating beacon or location identifying information to the device, the device can then know (or tell a back-end server) that the device is in some proximity to the communicating beacon. Thus, it is reasonable to assume then that the person performing verbal input into the device is also at the same location (excepting lost/left-behind devices, for example). The system can even be used to find lost/left-behind devices, however, because GNSS coordinates of the device in a 10 story building may not sufficiently distinguish on which floor the device is located, whereas a 7^{th} floor beacon communicating with the device would indicate a much more precise device location.

Once the device/user location is known, context data related to that location (either transmitted by a beacon or, for example, retrieved from a back-end server) can be used to refine a vocabulary of “things related to that location.” Initially, this vocabulary could be configured by an administrator, so that some base-vocabulary could be known with respect to a location. Over time, however, the vocabulary could grow and change based on observed user behavior, such that the users actually inputting verbal requests at the location serve to refine the vocabulary for that location or that location and similar or related locations. Context can include, but is not limited to, a location identification, resource identification (facilities, exhibits, stores, elevators, etc.), event identification, temporal event identification (e.g., a class), etc.

In a non-limiting example based on the university/beacon model, a student may receive broadcasts from three or more beacons deployed at the student union. By the relative signal strengths of the signals received from each beacon, for example, a fairly precise location of that user can be determined. The user may broadcast the received information to a back end server, which determines that the user is located in a food court, standing in front of a hamburger provider BurgerWorld.

The contextual information of “student union,” “food court,” and “hamburger provider,” and “BurgerWorld” may be stored with respect to one or more of the individual beacons, or may be identifiable from the user's location applied to a building map, for example, using various a-priori associations or real-time learning systems that could determine beacon position on a map, including context for that/those locations. Using this information, if the student speaks verbal input, sources of possible vocabularies related to the input could include words relating to the school, the student union, food, meals, hamburgers, meat, etc. Even if fifty contextual aspects of the location could be determined, and each aspect had its own associated vocabulary, assembly of all those vocabularies into an initial search vocabulary would still likely result in a vocabulary far less expansive than an all-possible-words type vocabulary.

Further, to the extent that the verbal input had anything to do with any of the identified context, false positive results could be reduced by excluding (through non-inclusion in the varied contextual vocabularies) similar sounding but unrelated words. It is recognized that some number of “random” verbal input will still exist at any location, but since the system can still search the all-possible-words type vocabulary or apply other existing search algorithms, if an appropriate result is not found within the contextual vocabularies, these inquiries can still be handled.

So, for example, if the student asked “what time does BurgerWorld open?” the use of local vocabularies could exclude possible false positives such as “burger whirl,” “burglar world,” “burglar whirl,” etc., since, in this example, “burglar” and “whirl” do not appeal in any of the vocabularies related to local context.

Decisions can be made about what level of refinement of context to use based on the given situation. For example, if there was also a frozen yogurt stand known for swirled yogurt and called BigGurtWhirl at the same food court, a vocabulary for the whole food court might include the words “burger,” “big,” “gurt,” “biggurt,” “world,” “whirl,” “burgerworld,” and “biggurtwhirl.” But, if a location specific vocabulary finely tuned to the user's specific location in front of BurgerWorld was first used, the words “biggurt” and “whirl” (possible points of false positives) would be excluded. Of course, if the user standing in that location was actually asking “what time does BigGurtWhirl open?,” a false positive first result may still occur (using the very tailored location specific vocabulary). But, the system could quickly expand to the more localized general food court vocabulary and thus encompass BigGurtWhirl while still excluding a variety of additional false positives. Or the system could present ordered results based on iterative searches of expanding vocabularies, which, in this case, might be ordered ranging from the specific BurgerWorld location to a broader food court location (including BigGurtWhirl) and which would still likely identify the most probably of the two match candidates as the first two choices.

Decisions about the level of precision to use in determining an initial vocabulary can be made, for example, in advance by an administrator or in real-time by an algorithm, and can be based on, for example, number of words in a resulting vocabulary, previously observed confusion between two proximate location vocabularies, time required to assemble (if needed) and iteratively search expanding vocabularies, number of permitted likely results, required degree of match-certainty in projected results, etc. Individual users could also fine tune their own systems based on user preferences (e.g., one user could ask a lot of proximity-unrelated questions and thus request more expansive vocabularies, whereas another user exploring campus locations may want to at least temporarily enable very location specific vocabulary refinement to improve the quality of locality related input).

Also, because the vocabularies can adapt in at least some models, seemingly random input by a sufficient number of people can actually result in inclusion of the elements of those input in at least the local vocabulary(ies).

In at least one example, the user may be running an application that is specific to the school, for example, and this will likely increase the chances of the input being contextually related to the school-based location. Thus, in some instances, contextual vocabulary may be selectively utilized when more is known about the type of inquiry (e.g., application specific) being made. For example, without limitation, a doctor could have a general speech recognition application and a hospital provided application, and the hospital provided application could utilize context based vocabulary while the general application would use a broader vocabulary.

While the beaconing system described herein allows for a relatively precise identification of user-location, other location-identifying systems can also be similarly used. Even if a location is only generally known (e.g., without limitation, GNSS coordinates indicate that a user is somewhere within the student union, based on a last acquired satellite fix near a building entrance, as GNSS has difficulty working indoors), the same principles for vocabulary selection can apply, it just may be more difficult to select highly precise location-related context. But even the general context of the student union could be sufficient to include all sub-contexts (which, in this example, would include the food court and individual restaurant contexts, and thus would include the words needed to satisfy speech-to-text translation of either of the exemplary inquiries).

In the illustrative examples, a plurality of location-identifying devices are deployed in a network stretching over a location. As noted, the location can range from a room or a home, to a corporate or institutional campus, to an entire city or larger. Because each device identifies a discrete location, characteristics of that location can be initially input. Further, additional characteristics of interest to people passing by that location can be learned through crowd-sourcing, as data is gathered relating to users interacting with devices in communication with the location identifier.

For the sake of illustration only, and not to limit the scope of the invention, a network of devices deployed throughout a university campus will be used to provide illustrative examples. In such an environment, when a device is initially deployed, it can be associated with certain characteristics that can help create a context for the location. For example, without limitation, the device/location can be assigned characteristics such as a building name, types of facilities (departments, classes, classrooms, lecture halls, labs, services, etc.) provided within the building, operating hours of the building, building type, etc. Or, in another example, the location (either the specific location, or, for example, without limitation, a building) may have the characteristics associated therewith, and the device may serve as an identifier to indicate that a user in a detection range of the device is possibly present within the building. Any suitable paradigm for associating desired characteristics with the device in a retrievable manner may be utilized.

It is also possible to use GNSS coordinates as a proxy for the device, if the coordinates are available. Currently, however, many locations within a building are blocked from GNSS access due to interference, and it may be difficult to utilize a universal coordinate system as they currently exist to identify discrete locations within a building, which may have their own context associated therewith. One method of using GNSS coordinates to “guess” at a location in the building is known as dead-reckoning, whereby a last-known GNSS coordinate is used and then, through, for example, device sensors (accelerometers, compass, etc.) movement of the device (and presumably the user) following the last known coordinate set is approximated. Of course, in such a system, minor inaccuracies tend to compound over time, and the accuracy of a given location will likely diminish the more a user moves within the building. Nonetheless, if a suitable degree of accuracy can be obtained (or if a location identification system can accurately identify a location), such systems can also be used in conjunction with the illustrative embodiments.

Based on an initial context associated with the characteristics, among other things, a location specific vocabulary can be obtained. Other contextual clues, e.g., without limitation, time of day, day of week, date, month, year, weather, proximity of other users, social media profiles, and user personal information may also be used to augment the vocabulary set or change which vocabularies are selected. Over time, crowd-sourcing can be used to determine any words or context that may be frequent to the location, but not yet identified. This crowd-sourced data can also be used to refine vocabularies for both the specific location and for characteristics of the location.

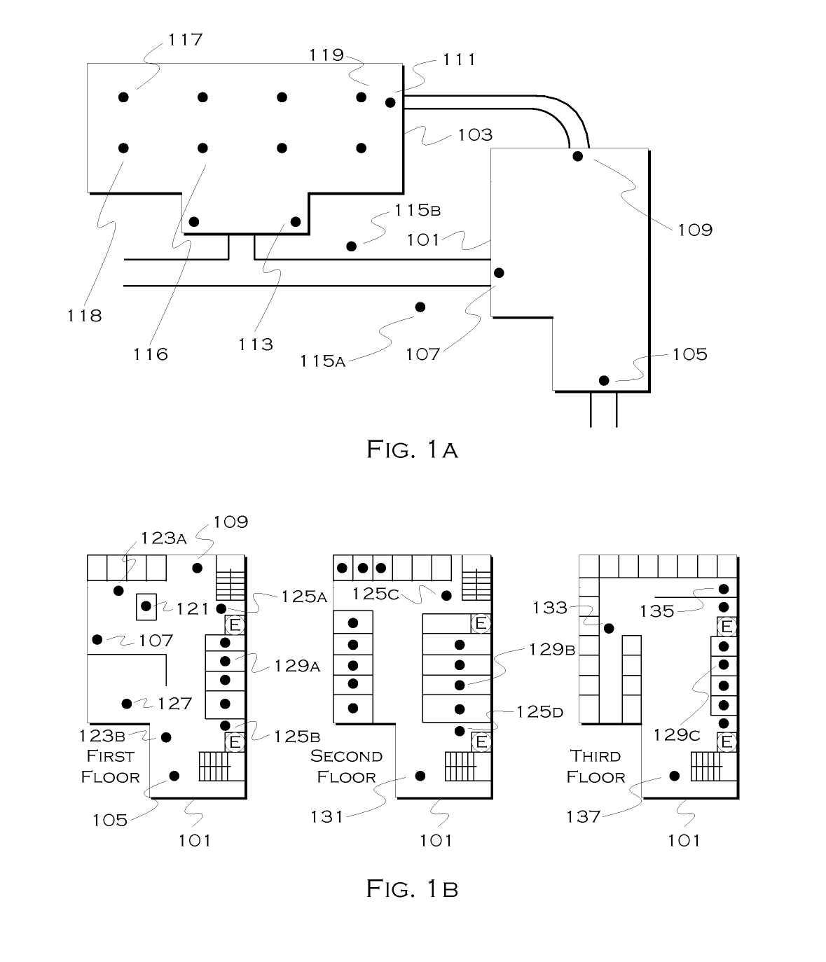

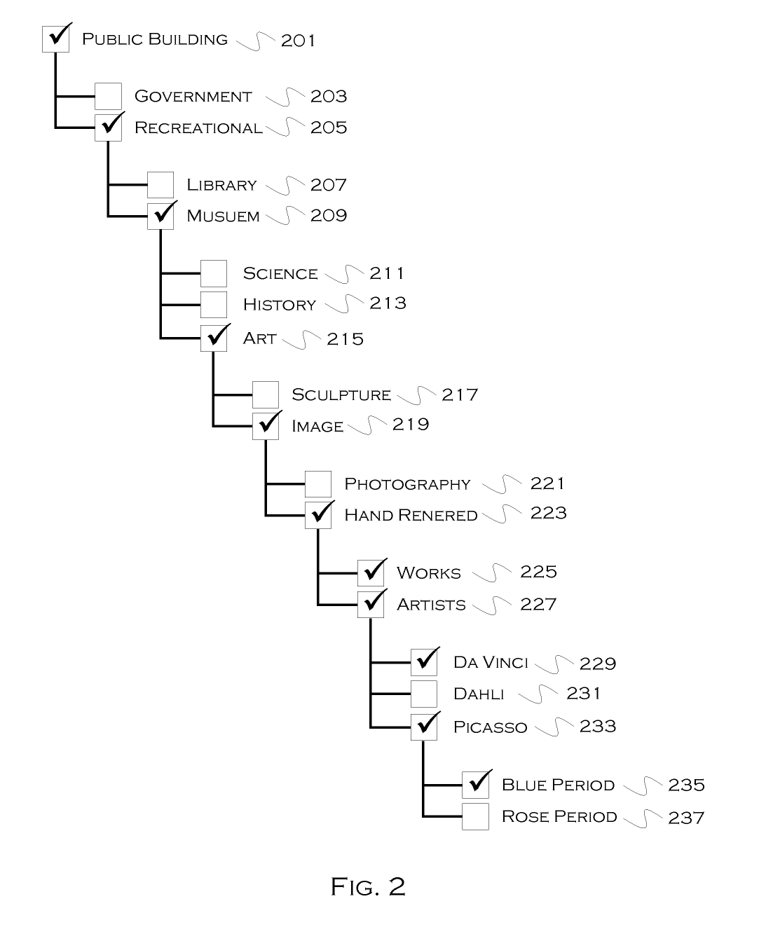

A non-limiting example of the application of illustrative versions of some of these concepts could be as follows. FIG. 1A shows an illustrative layout for several university campus buildings, as well as beacon-device deployment in an illustrative setup. FIG. 1B shows an illustrative floor plan of building 101, with illustrative beacon deployment on multiple floors.

In FIG. 1A, a number of BLUETOOTH or other wireless location identification providing devices are deployed in an illustrative configuration as shown. Here, in this example, there are two buildings, a general studies building 101, and a library 103.

Since a general studies building may house a variety of classrooms related to a number of subjects, there may be no specific department (e.g., chemistry, English, etc.) relationships affiliated with the building. On the other hand, in another example, all departments which teach classes in the building 101 may have their particular relationships affiliated with the building. For example, assume that both chemistry and English classes are taught in building 101. A Chemistry vocabulary, which may be tailored for the university context, may be associated with the building. Also, an English (the department, not the general language) vocabulary may be associated with the building.

Using chemistry as an example, a number of possible initial vocabulary inclusions may be included. Chemistry terms, chemical names, chemical principles, and other chemistry-related words may be included in a general “chemistry vocabulary.” This vocabulary could be developed independently, and could be applied any time a context system had a chemistry affiliation (e.g., without limitation, chemical plant, pharmaceutical lab, high school chemistry department, hospital lab, etc.). Thus, a generic vocabulary related to chemistry could be deployed across a variety of instances. In addition, in this example, the university chemistry department may include a number of department-related words in a vocabulary, such as, but not limited to, faculty names, class names, other buildings including chemistry classes, etc. This could also be included as part of a building vocabulary, for this and any other chemistry related buildings on the university.

Another non-limiting affiliation could relate to school-related terms, such as, for example, cafeteria/food services, snacks, computer labs, classrooms, etc. Thus, a basic version of a building 101 vocabulary could include chemistry words, chemistry department words and school-building words. This is a very rudimentary example, and many additional base vocabularies could be included in an initial vocabulary (some additional examples are given with respect to FIG. 1B), but it demonstrates how a basic initial vocabulary can be formed.

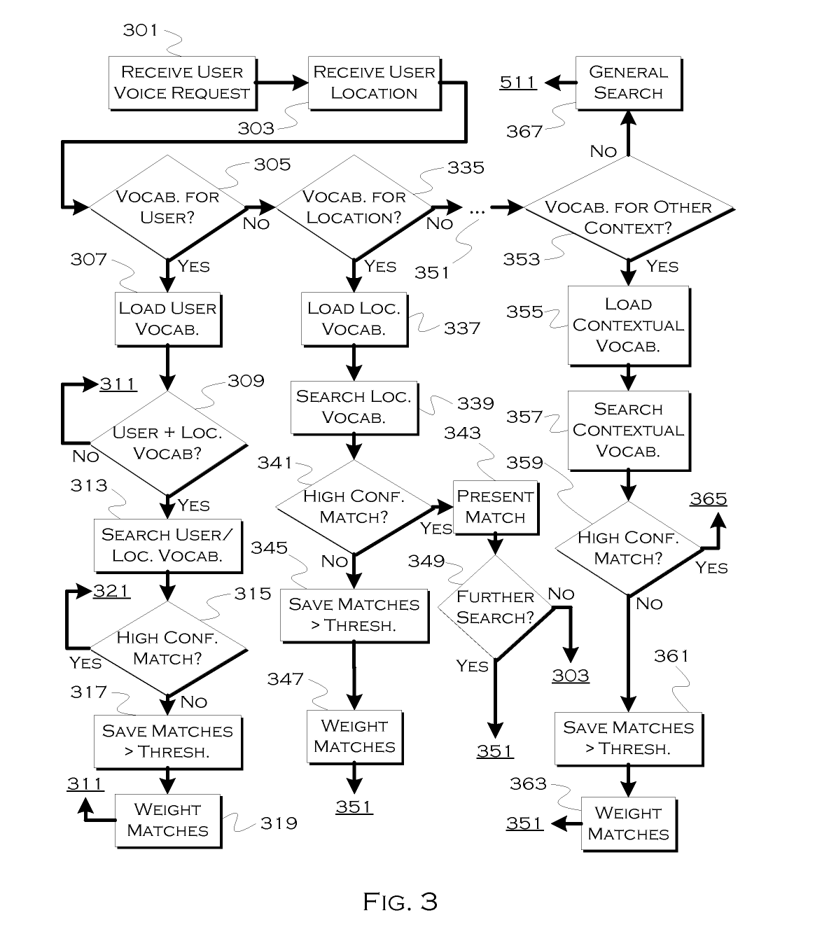

In one example, the vocabulary is stored on a device-accessible resource such as a server. When a user utilizes speech input on a device, the device, knowing that it is in a context-enriched environment, may access the server to utilize any useful vocabularies relating to a user-location. More examples of vocabularies, their development and utilization are discussed with respect to FIG. 2.

In the example shown, the library 103 has a number of location-identification devices (“beacons”) provided thereto. While the examples use beacons, as previously stated, locations can be identified by a number of techniques, and generally provide one basis for context as discussed herein in illustrative form. Utilizing location based services does not, however, necessarily require the use of a beacon-type system.

In the library, there are entrance beacons 111, 113 deployed at various entrances. Depending on the range of beacons, if beacons are used for location identification, a plurality of beacons may be deployed at a large entrance. Additionally, extra beacons may make location pinpointing easier, which could be useful, for example, in the next instance. In addition to the entrance beacons, in this example, a multitude of beacons 116, 117, 118, 119 are deployed throughout the library stacks. Utilizing a larger number of beacons may make it possible to determine, through proximity determinations, for example, a user location within the stacks. Vocabularies related to topics in that location and, for example, a specific catalog of books in that location could be some of the vocabularies associated with a specific location in the stacks.

If beacons are utilized in a deterministic manner as above, it may be useful to affiliate vocabularies with locations within a building as opposed to the beacons themselves. For example, with respect to beacons 116, 117 and 118, user proximity to each beacon may dictate which specific section in which a user is present. A vocabulary could be dynamically assembled based on this context that include, for example, building general vocabulary (since the user is in the building), university general vocabulary (since the building is part of the university), and topic specific vocabulary (e.g., without limitation, titles, authors, concepts) based on a current section and/or surrounding sections. In other examples, where beacons may be infrequent enough to not be used as, or electively not used as triangulation devices, and rather simply identify specific locations (or proximity to specific locations), the beacons themselves may have vocabularies associated therewith.

Also in FIG. 1A, a walkway leads from the library to the general studies building 101. In this example, beacons are provided along the walkway 115a, 115b and can be used for informational and, if desired, security purposes (e.g., emergency location identification). In yet another example, observation of ordered beacon-passing can help provide logistic/analytic information relating to flows of foot-traffic. The general studies building, in this example, also has entrance beacons 105, 107, 109 provided thereto.

FIG. 1B shows a more specific, non-limiting example of beacon deployment throughout a general studies building 101. Context based vocabulary association will be discussed with respect to the deployment of these beacons, in a number of non-limiting, illustrative examples.

In this example, the three entrance beacons are shown 105, 107, 109. Each entrance beacon may be used to determine a location-affiliated vocabulary associated with the beacon, the entrance, the building, etc. (as desired). For example, each entrance may draw from a general building vocabulary relating to predefined information for school buildings in general (e.g., without limitation, common words such as elevator, rest-room, classroom, etc.) and entrance-specific information (e.g., north entrance 109 may be adjacent to a parking lot typically used by faculty, so may have faculty related vocabulary associated therewith, parking related vocabulary, etc.). South entrance 101 may be proximate to a bus stop, so may have bus-related vocabulary associated therewith.

With respect to any vocabulary for a given building, for example, the vocabulary can be structured such that a search at a given location first searches the location specific terms, then, for example, building specific terms (e.g., other vocabularies associated with other locations in the building), then, for example, in this instance, university campus-sector specific terms (e.g., vocabularies associated with all or select locations within the campus sector) and then, for example, a general vocabulary if no suitable match is previously found. In practical terms, this means that a student standing at location 109 and searching for bus-related terms, or a faculty member standing at location 105 and searching for parking-related terms might not find a match in the precise location specific vocabulary, but would still find a match in the building related vocabulary (because it would potentially encompass both vocabularies specific to 105 and 109), before having to turn to a broader vocabulary to find a result (which can increase response time and decrease accuracy).

Also shown in this example is a food stand with a beacon 121 affiliated therewith. Accordingly, food-related vocabularies could be included with respect to, for example, without limitation, any location on the first floor, any location in the building, entrance 107, entrances 107 and 109, etc. Similarly, a computer lab 127 is present in this location, which could have its own location vocabularies associated therewith. Vocabularies can also be affiliated with, for example, floors of a building, so that all locations on a given floor could draw on “unique” features of the floor (in this example, a computer lab and a food stand) for their particular vocabularies.

In some instances, it may be desirable to include a mixture of location-specific and beacon-specific vocabularies. For example, if the food-stand were a mobile food service, then when the beacon 121 is present, “food” vocabularies could be added to the local vocabulary (based on a back-end recognition by a managing server, for example, of beacon 121 location correspondence with building 101). This could be useful when setting up information kiosks. For example, if a job-fair were on campus, each employer could have a beacon with employer-specific vocabularies. These could be affiliated with whatever building the fair was in for as long as the fair was there, since presumably searches for these terms would increase for users at that location.

In an instance such as above, common input of an employer name may cause the usage level to rise to a point where it is contemplated to add the word to a local vocabulary. But, because the system can know that the usage is due to a mobile context vocabulary, it can avoid adding the word to a long term vocabulary, where decay would have to act to remove that word from the vocabulary. Instead, when the beacon moved out of the building, all words related to the beacon could move out of the vocabularies (to the extent those words were not already included). In this manner, vocabularies can be quickly and dynamically expanded or contracted to meet changing conditions, without relying on crowd-sourcing to modify existing vocabularies. On the other hand, the vocabulary associated with the mobile location might be amended based on crowd sourced data relating to words within that vocabulary.

Vocabularies for locations (e.g., without limitation, buildings, locations within buildings, geographic areas, etc.) can change over time based on observed usage derived from crowd-sourced data. Words that are not commonly used may have a decay factor associated with them, so that, if a decay threshold is passed, they may be dropped from the vocabulary. Words may also have general usage values associated therewith, so that more commonly used words with respect to a given location are more likely to be selected. Vocabularies can also be manually amended if desired.

FIG. 1B also shows two bathroom locations 123a, 123b located therein, as well as elevators 125a, 125b and a classroom 129a. In this example, some or all of the classrooms have individual location identities, which can allow for classroom or class specific vocabularies to be associated with the classroom. Even the presence of a mobile device can be used to shift a vocabulary, in accordance with the illustrative embodiments. For example, a given professor can have a personal teaching vocabulary associated therewith. When a professor location coincides with a classroom location, the classroom location vocabulary can be expanded to include a vocabulary relating to that professor's vocabulary. This could be even further refined based on time of day and vocabularies associated with different classes. For example, a professor with a geometry vocabulary might have a geometry class at noon, so based on a classroom location of the professor and a time of day compared to a schedule, the classroom location vocabulary could include the professor's personal geometry vocabulary. Later in the day, a new time (even in the same classroom, with the same professor) could shift this inclusion to add a calculus vocabulary instead of a geometry vocabulary. These are just a few examples of how location vocabularies can be tied to both static and dynamic locations, and how static location vocabularies can shift based on the presence of dynamic-location affiliated vocabularies. The same professor in, for example, a hallway, might not cause a change in the hallway vocabulary, because presumably the professor is not in the hallway to teach.

Even in the absence of the professor, classroom vocabularies might shift over the course of a day. Since classes are typically held based on a regular schedule, the mere meeting of time and location might be sufficient to shift a vocabulary to include class-relevant information. This allows for the professor to be late, or for a guest lecturer, and the vocabulary to still be context relevant.

Lecturers could benefit from the dynamic vocabulary association as well. A lecturer could develop a general vocabulary for each lecture, or a personal vocabulary covering all lectures, and then, upon correspondence of the lecturer within a location designated as a “lecture location,” the vocabulary could be dynamically added. This could allow audience members to search for lecture-related terminology with greater accuracy, but would not necessarily affect the long-term vocabulary associated with the lecture hall.

On the second floor of building 101, there are additional elevator locations 125c, 125d, classroom locations 129b and a study-area location 131. The elevator 125c, 125d locations may share some vocabularies with the previous floor's elevator locations 125a, 125b (such as, for example, without limitation, elevator related vocabularies) and may also share some floor specific vocabularies that the first floor elevator locations do not include. For example, the locations could include a vocabulary related to the study-area located on this floor. In one example, all elevator locations could share a vocabulary including identification of locations (e.g., the study area) on any floor, since a user may be standing on one floor and searching for a location on another. And then, for example, specific vocabulary related to the study area could be included with the elevator locations on the second floor, but not the first floor. Which vocabularies to include with which locations is largely a matter of personal deployment choice, and is not intended to be restricted by any of the illustrative examples provided herein.

On the third floor of the building are additional classrooms 129c, a faculty lunchroom 137, and two departments 133, 135. Each can have appropriate vocabularies associated therewith. Each department, for example, could have the department-specific vocabulary, student assistance vocabulary (including terms such as “office hours”), and any other departmentally useful vocabulary. The lunchroom could have a common lunchroom vocabulary as well as a common, daily or even per-meal specific menu vocabulary (e.g., without limitation, it is far more likely that a person will be searching for “gluten free” in area 137 than, for example, in area 129b).

In the illustrative example, specific vocabularies can be associated with specific locations, and those vocabularies can change for those locations based on observed word usage. It is also possible to import changes to other locations, if sufficient parameters for a change to a general base vocabulary are met.

For example, if a “dinosaur” vocabulary were affiliated with paleontology wings of museums, it might be observed that the word “brontosaurus” was infrequently or never used (since it has been determined that a brontosaurus is actually a combination of two dinosaurs). At a large museum, where a number of words are commonly used (such that a meaningful distinction can be drawn between infrequently used words and frequently used words), it may be that “brontosaurus” decays sufficiently based on usage to be removed from the dinosaur vocabulary. This may also be observed at other significant museums where meaningful amendments to vocabulary can be made. Then, for example, changes to the common dinosaur vocabulary may be prevalent enough at specific locations, that a change is implemented to the common based vocabulary associated with dinosaurs.

This change could be, for example, propagated over all or any number of locations utilizing the base dinosaur vocabulary. Thus, even in a small museum, where there is limited enough speech-recognition utilization to derive sufficient distinction between commonly and uncommonly used words for the majority of a vocabulary, a meaningful change can be made based on behavior observed elsewhere. The same principle can be used to add words to a common vocabulary having a base-designation (e.g., if sufficient usage at varied locations causes a word to be frequently added to a common vocabulary, perhaps it is worth adding to the base vocabulary set for future utilization and utilization at sites where the word was not yet added).

Any number of common vocabularies can be generated and utilized as appropriate. For example, there may be a general museum-art vocabulary that covers celebrated artists and their works. If a new artist becomes popular, frequent enough usage of the artist name or the name of a work may cause the addition of that word to a vocabulary. But there may also be individual vocabularies associated with specific artists.

For example, without limitation, there could be a generalized museum-art vocabulary that includes a base set of artist names and most famous works. Then, a second vocabulary could be established for each artist, including more artist-specific words and a full catalog of works. This could be broken even further down into artist periods for a given artist.

Dynamic management of the vocabulary system can also be provided, such that vocabularies can be added or removed as needed. To use the museum example, FIG. 2 shows a number of vocabularies arranged in a tree structure. Relevant vocabularies for that museum can be selected as appropriate.

In the non-limiting example shown with respect to FIG. 2, a non-exhaustive list of possible vocabularies for a public building is shown. For any site used in conjunction with the illustrative embodiments, such a list could be derived. A certain site type (here, public building), could have a set of common vocabularies associated therewith, from which an administrator could select the relevant specific vocabularies for that site. Of course, vocabularies not in the base-set can also be added as desired (e.g., a history museum does an exhibit on the history of football, and adds a football vocabulary, since that is not typically related to the core museum vocabularies). Selection of the public building option 201, in this example, will import terms and words relating to a general public building vocabulary (e.g., without limitation, open, close, etc.). While these words may seem to be common enough, the word “close” is easily confused with the word “clothes,” and thus a vocabulary related to a public building that includes “close” but does not include “clothes” should result in more accurate hits for requests such as “what time does this building close.” Some assumptions may be made when vocabularies are crafted, such as that it is more desirable to accurately satisfy the requests of the thousand people asking about building hours, as opposed to the single person asking whether or not the building is ours. Since in the paradigm suggested above, “hours” and “close” will likely be included in the public building vocabulary and “ours” and “clothes” will likely not be included (unless the building has another vocabulary relating to possession or clothing), use of the word “hours” or “close” should return an accurate result.

Sub-vocabularies included with the public building category are government 203 and recreational 205. These are presented as sub-vocabularies, but for the sake of convenience only. Each vocabulary can be developed independent of any other vocabulary, and may contain overlap of phrases, terms and words. If presented as a selectable interface, an appropriate tree-association of vocabularies can be developed for example, to improve the ease of vocabulary selection and compilation. Both associations and vocabularies can be developed and utilized by any solution implementing the illustrative embodiments, of which the vocabularies and associations form a part. Presumably, although not necessarily, these will be developed by someone knowledgeable in a given field.

Further, just as the vocabularies can dynamically adjust based on observed behavior, the associations can adjust. If a new vocabulary is developed and commonly included in conjunction with a previously existing or other new vocabulary, these relationships can be tracked and offered as suggestions for other users implementing similar solutions.

Under recreational buildings, in this example, libraries 207 and museums 209 are included, again each having a vocabulary. Because this vocabulary is being selected as a base vocabulary for a museum, which does not include a library in this example, only the museum vocabulary was selected.

Three types of museums, science 211, history 213 and art 215 are presented in this example. Since this example relates to an art museum, the art museum vocabulary has been selected. Sculptures 217 and images 219 are also presented in this example as types of art, and images has been selected, since no sculptures are present in the museum. Also, only hand-rendered images 223 has been selected, and photography 221 has been ignored, since this collection only deals with hand rendered images.

Another set of subcategories, works 225 and artists 227 has had both items selected to provide a general vocabulary relating to famous artists and works. This could be a vocabulary of famous hand-rendering artists and hand-rendered works or it could be a more generalized vocabulary of artists and works. For example, a curator may determine that people like to compare art that is present with art that is not (the same for artists) and thus may include a broader vocabulary in certain areas than actually encompasses the collection, because of the potential relevance. On the other hand, the curator could rely on the crowd-sourcing methods discussed herein to generate new terminology for a more collection-specific vocabulary. Use of crowd-sourcing can also generate some interesting analytical results, for example, the addition of Artist B to an Artist A vocabulary based on use of Artist B's name in text or speech input in the locality of Artist A's works, can indicate that people tend to associate Artist B with the works of Artist A.

Under artists, a non-exhaustive (obviously) list of artists is shown. Here, the works of Da Vinci 229 and Picasso 233 have been selected and the works of Dali 231 have been ignored. Then, for example, if a new exhibit on Picasso's blue period recently opened, the curator might also select a blue period 235 specific vocabulary, ignoring a rose period 237 vocabulary. In another example, beacons included with temporary exhibits might act as temporary vocabulary modifiers as discussed previously with respect to the food cart, and could automatically cause selection of vocabularies associated with those beacons. The system could also track previous and temporary selections, such that when the exhibit was removed, even if the exhibit dictated Picasso and blue period vocabularies, only the blue period vocabulary was removed from the museum vocabulary, because the curator had selected Picasso at an earlier point in time. Or, for example, without limitation, museum staff, such as a curator, could remove and add appropriate base vocabularies as exhibits arrived at and left the museum. These vocabularies could shift over time, at least while they were engaged, based on crowd-sourcing. And, for example, if a vocabulary was ever removed and added later, that vocabulary could be reset for that location, or it could include all previously observed crowd-sourced words.

Using all the selected vocabularies, a base vocabulary for the location (or context) can be formed. While the illustrative embodiments largely discuss location-based vocabularies, context-based vocabularies can be formed in a similar manner, based on a definition of context (e.g., noon, rainy, Friday) or commonly occurring context (e.g., dynamically develop a vocabulary based on words requested at noon on rainy Fridays).

Because there are a near-infinite number of location/context combinations that could define a vocabulary, in at least one model each word may have affiliated contexts associated therewith. For example, a database of every single word ever requested (which can also have constraints on adding and removing words based on minimum usage, for example) could have associations with each word usable to assemble a vocabulary on demand. In the museum example given above, for instance, the word “art” may be associated with the following non-exhaustive contextual identifiers: museum, art museum, image, sculpture, photography, hand rendered image, artist, artworks, Da Vinci, Dali, Picasso, Picasso blue period, Picasso rose period.

Selection of any of the contextual identifiers may result in inclusion of the affiliated word. Inclusion thresholds may also be included with the context identifiers when the context group is defined, and frequency values may be associated with each word-context pair, such that only words of a certain frequency used within a certain context are selected. These values can adjust based on observed usage and decay based on non-usage. The values may also be relative to other words in the group, or may be independent of some or all words. Or, for example, they could represent a numbered ordering of frequency within a group.

Adjustment of frequency could be based on observed usage and is discussed in greater detail later herein. Briefly, if the word “art” is used twenty times in a location having contexts “museum,” “image,” “hand-rendered,” “artist” and “artworks” associated therewith, the word-context values can be adjusted accordingly. If the word is used fifteen times in the Picasso blue period exhibit (a more specific location in the museum, having contexts “Picasso” and “blue period” also associated therewith, if such distinctions are made), a lesser adjustment of those word-context values may be made. Suitable adjustment can also be made to broader word-context pairings as well (e.g., without limitation contexts such as “time of day,” “day of week,” “date,” “rainy weather,” “summer,” “University of Michigan,” “Ann Arbor, Mich.,” etc.).

Depending on the speed of the processing device, be it a local device, cloud server, local Wi-Fi connected server, etc., dynamically assembling a vocabulary may take some time, if a large database needs to be parsed. Even with efficient database design, it may be desirable, if possible, to assemble vocabularies for a known context in advance. With respect to locations, since the context is at least partially location-dependent, at least the portion of the vocabulary relating to the location can be assembled in advance for access by anyone at that location. This can be used independently, or can be combined with one or more previously or dynamically assembled contexts.

In another example, sufficient processing capacity may exist to dynamically assemble vocabularies on-the-fly in the cloud. But, an application utilizing the cloud at a certain location may observe that connectivity is spotty or intermittent. Accordingly, the application may request assembly of and delivery of vocabularies for that location (likely, although not necessarily, encompassing most vocabularies for the location or vocabularies at the broadest level). This way, if connectivity is lost, local processing isn't presented with the task of assembling vocabularies locally (if such an option even exists), or left searching the all-known-words database for speech matches.

Very specific contexts can be assembled in this manner if desired. For example, if there was a context vocabulary for Building 101 previously assembled, and a word-context available for rainy days, and a user was in Building 101 on a rainy day, based on commonality of words between the two groups, indentified, for example, by the word-context pairs, a vocabulary for “Building 101 on a rainy day” could be assembled as a very specific based vocabulary. This could help limit a broad context “rainy day,” but might overly narrow an already narrow context “Building 101.” In at least one example, context assembly could be based on, for example, narrowing a vocabulary until a predefined word threshold is reached (e.g., without limitation, narrow the vocabulary until it is under 3,000 words). In other examples, where speed is a consideration, only predefined/preassembled contexts may be utilized, to avoid overhead in assembling a new context.

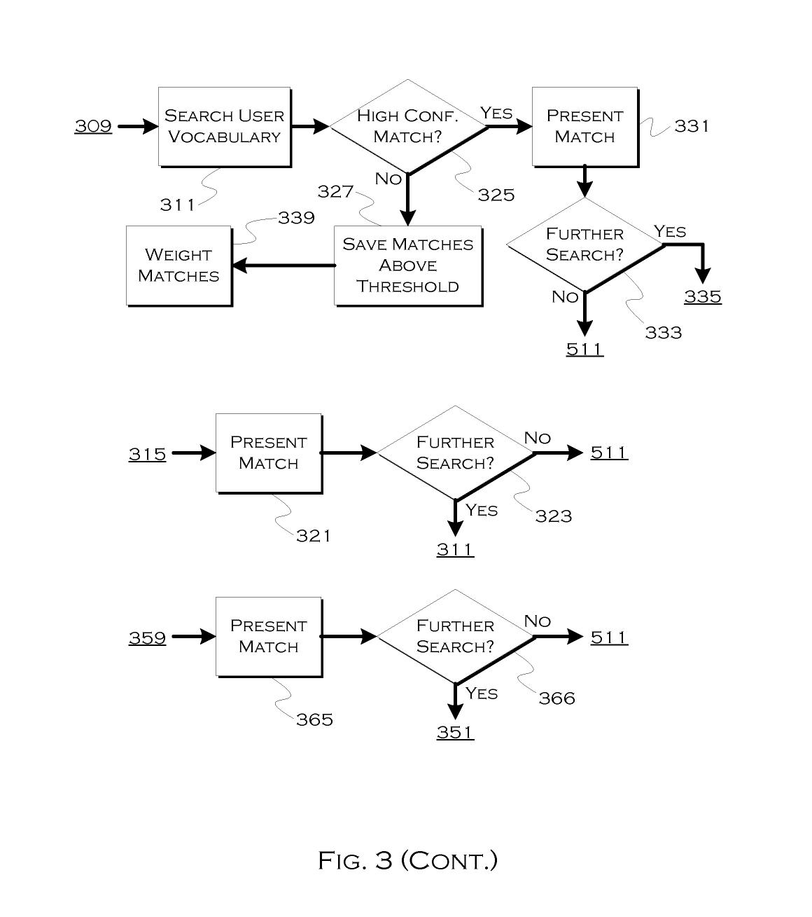

FIG. 3 shows an illustrative process for context-augmented speech recognition. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Through access to location-based and otherwise context augmented vocabularies, a system can return search results in response to input with increased speed and accuracy. FIG. 3 shows a non-limiting example of a process for performing a search, following user input, utilizing some of the illustrative location-based vocabularies discussed herein. With respect to any vocabulary, it is understood that a set of highly common words (e.g., without limitation, articles “a,” “an,” “the,” etc., connectors “and,” “or,” and the like) may be included as some “generic” vocabulary, or included with every vocabulary. Many words that a speech recognition system will have difficulty in distinguishing though, can be included in specific vocabularies, as can be words related to the location, a topic, or having any other suitable applicability.

In the illustrative example shown in FIG. 3, the process receives a request from the user in the form of voice input 301. Although not shown, the input could similarly be text, and the context-specific vocabulary could be used to verify the accuracy of input text as well. The text input might be useful, for example, in identifying names and local slang, as well as commonly misspelled local words that the user might intend to actually misspell at that particular location or in that particular context.

In this example, the vocabulary is based at least in part on a location context, so the process also receives a user location 303. This could be determined by the beacon system as in FIG. 1, or could result from GNSS or some other coordinate or location identifying system or service.

In addition to utilizing a context-based vocabulary, the process may also have access to a user specific vocabulary 305. This can include, but is not limited to, words commonly used by the user. This could also identify what is intended by a certain sound output by a user, e.g., without limitation, “yallgunta” could be identified for a user as “y'all going to” based on previous observed results and user-corrected input. If there is a user-vocabulary 305, this may be loaded 307 or included in the overall vocabulary for use in determining the voice input.

Also, in this example, there may be a vocabulary previously defined for a user+the location 309. This can be a more limited version of the user vocabulary, based on words that the user has commonly used at that location. With respect to the building 101 example above, for instance, without limitation, a chemistry major is probably not searching for English classes in building 101, so the chemistry major may have a chemistry class related vocabulary defined with respect to building 101, and/or with respect to one or more locations within building 101. Similar user+context vocabularies could be established for other contexts as well.

If there is a user+location vocabulary available, that is, in this non-limiting example, the basis for beginning a search. In this illustrative example the process may perform several searches, using expanding vocabularies, and in other examples, the process may expand a vocabulary to a certain point before performing a search, depending on which is determined to be appropriate given the constraints of a system designer (e.g., is there greater cost associated with multiple searches or vocabulary assembly, also weighed against diminishing accuracy as a vocabulary broadens, etc.). In this example, the user+location vocabulary is searched 313. If a high-confidence match 315 is found, the match can be presented to the user 321.

The appropriateness of a given match can be determined by a particular search algorithm. In this instance, for example, it may be the case that the limited vocabulary is initially searched, without resorting to search in the broader vocabulary. Thus, the non-existence of a word or any similar sounding words in a context-based vocabulary may result in a no-match condition. On the other hand, if a match is found within the limited context, assumptions about the accuracy of the match may be adjusted based on the fact that the context vocabulary did actually contain a “close” word, and, because the word was within the context vocabulary, it might have a higher chance of being the correct word, than if the word was simply selected from the vocabulary of all words. The use of pre-existing speech recognition techniques can be included as appropriate with the exemplary algorithms discussed herein, and is not discussed within this disclosure, except to the extent that it can be used in conjunction with the vocabularies provided hereby, in order to increase result accuracy, speed, etc.

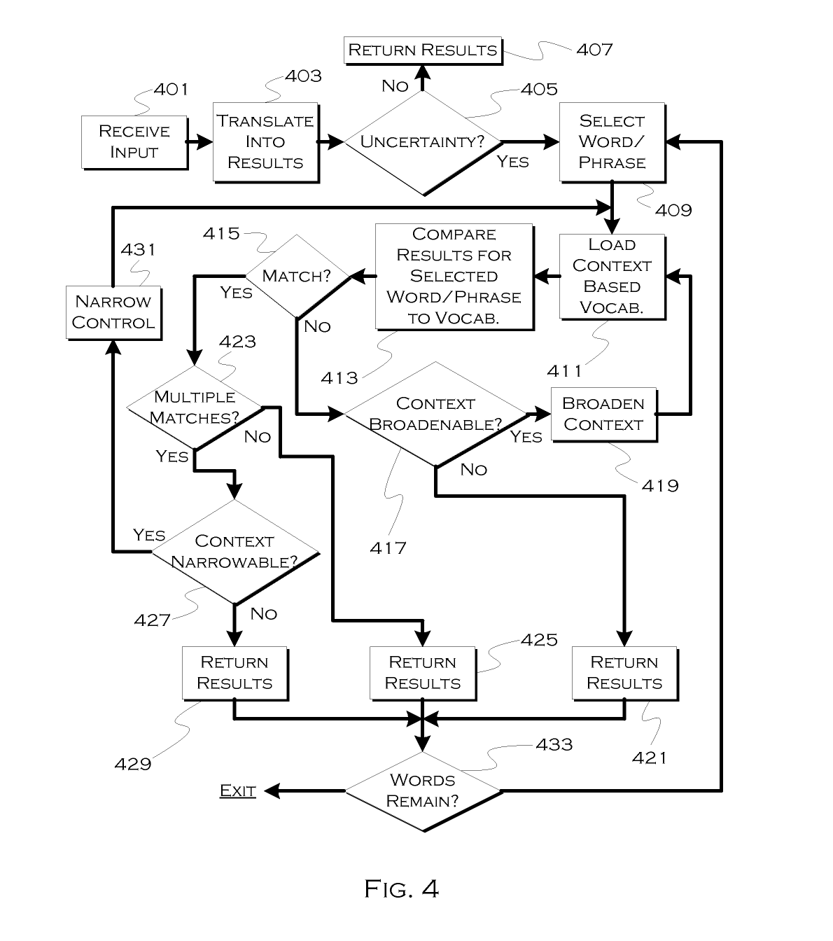

In another example, shown in FIG. 4, the context vocabularies may be used after a broader search is done, in order to improve accuracy. That is, if a word or words returned too many possible results following a broad search, application of a context vocabulary may help narrow those results. In such an instance, if desired, the word may not need to be phonetically searched, the possible results can just be compared to the words within the context vocabulary and one or more matches can be selected. If multiple matches exist, further phonetic analysis may be needed, or additional context might help further narrow the results to the likely appropriate candidate.

In the example shown in FIG. 3, there may also be one or more words within the vocabulary that provide some results above a threshold 317, but none with a high-enough degree of confidence to be presented as the final result at this point. Further application of additional vocabularies may reveal a new word having a higher degree of confidence. In this example, the low confidence matches are weighted 319 and then a broader user vocabulary is searched 311.

In this example, the user vocabulary is a broader set than the user+location vocabulary, so searching the user vocabulary will reveal additional match options beyond searching the user+location vocabulary. This can be useful from the perspective of finding a higher confidence match if no high confidence match was previously identified, but also can diminish accuracy if new words are introduced that a phonetically similar, for example, to words in a narrower vocabulary. Thus, any particular application may have to weigh the cost/benefit of moving to a broader vocabulary. The instance shown in elements 317 and 319, where no high confidence match was found in a narrower vocabulary, is one example of a reason why a broader vocabulary might be desired. Another non-limiting instance could be, for example, a narrower vocabulary so limited in size as to be virtually useless (e.g., below a threshold number of words).

Again the vocabulary is searched 311 and the process determines if a high confidence match was found 325. In this example, if two high confidence matches are found, for example, then they are considered to be non-high confidence matches, because each is a viable candidate. Other techniques (use of other words in the spoken phrase for sentence based context, for example) could be used to select a match, but if there is no suitable way to elect one match over another, both are treated as “low confidence matches” in this example. Any matches above a recognition threshold are then saved 327 and weighted 329. If a high confidence match is found, the process can present the match 331. Whether or not a high confidence match is found, the process can determine if further searching is desired 333.

For example, a high confidence match may be presented to the user, but may be the wrong word, so additional searching may be needed. Or, in the instance of low-confidence matches, the system may decide to present the matches and ask the user if further searching is needed, or continue searching to determine if a high confidence match can be found. If multiple words are phonetically very close and no further distinction can be made using other techniques, the process may present the words (e.g., without limitation, “hour” and “our”). But, if the words are above a possible match threshold, but below a confidence threshold, the process may continue to search (e.g., in the preceding example, the user actually said “are.”).

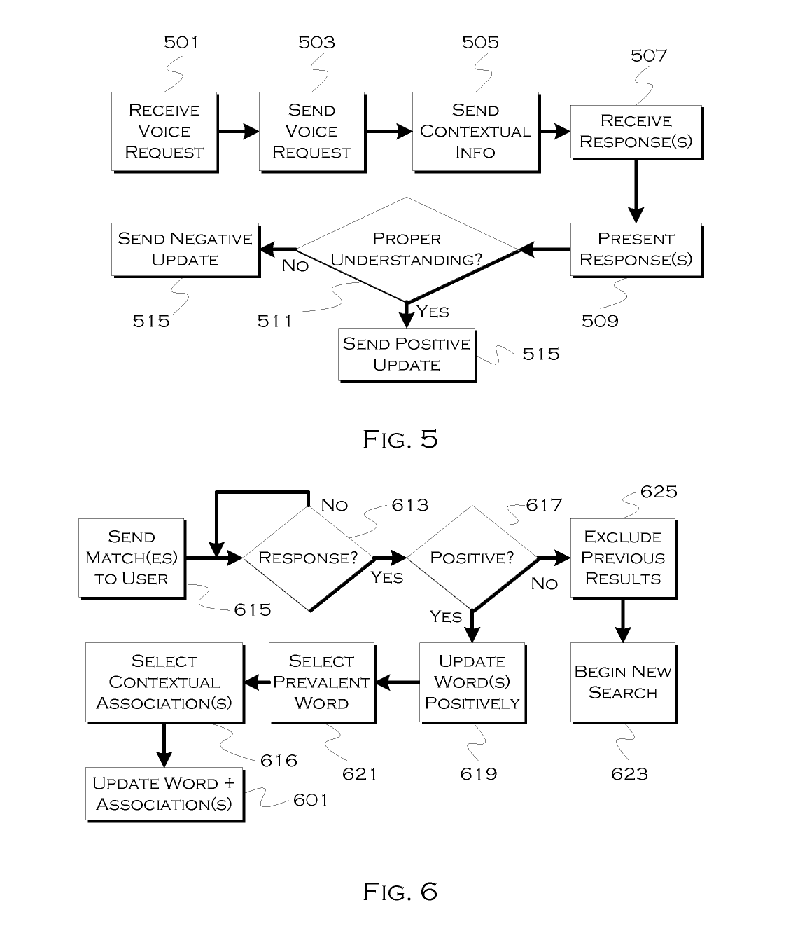

In this example, if no further searching is needed (e.g., the word or one of the words matches the intended word), the process may proceed to an update step such as element 511 of FIG. 5. Otherwise, another change in context is performed and the system determines if there is a vocabulary associated with the location 335. Although this example works from a user+location to a user to a location vocabulary (and continues to expand from there), it is noted that the initial search could actually begin at any suitable context level (e.g., at the location level), subject to the objectives and constraints of a given implementation.

In this illustrative example, if there is a location vocabulary available, the process loads the location vocabulary 337 and/or dynamically develops or adjusts the location vocabulary based on suitable context. The resulting vocabulary is then searched 339. If a high confidence match is found 341, as before, the result can be presented to the user 343. Also, as before, if matches above a threshold are found, the results can be identified 345 and weighted 347 in accordance with an appropriate paradigm (e.g., without limitation, phonetic correspondence, sentence-based context, etc.). Also, as before, the process can determine if any further searching is needed 349, which determination may or may not be based on user input (e.g., without limitation, if matches were presented and inaccurate, more searching may be needed, or, in a no user-input case, if no matches suitable for presentation were found, more searching may be needed).

Context can continue to expand 351 as needed. In a non-limiting instance of expansion, a vocabulary can be developed for any particular context limitations 353. This vocabulary can be loaded 355 and searched 357 as desired. High confidence matches can be identified 359 and presented 365, and matches above a base threshold can be identified 361 and weighted 363. Further searching 366 can be performed as needed at this point as well. When all contexts have been exhausted (within the constraints of a search, for example) 353, the process can perform a broader search on general vocabulary 367.

FIG. 4 shows an illustrative example of a post-search context vocabulary analysis of uncertain results. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a speech recognition process searches a general vocabulary based on received input 401, according to known paradigms, and returns a result 403. If any of the words have a threshold uncertainty associated therewith 405, the process can utilize context-based vocabularies to further refine the results. If the results are suitably appropriate, the process can simply return the results 407.

In this illustrative example, the process selects words or phrases from the uncertain results 409 for further analysis. A context based vocabulary of suitable breadth is selected 411, and the results (e.g., without limitation, multiple words or phrases, or a single word or phrase identified as the sole result, but with low confidence) are compared against the selected context 413.

If a match is not found within the context 415 (e.g., in this example, if none of the words or phrases are found within the selected context), the process may determine if the context is broadenable 417. In another example, a sound-based recognition process may be performed at some point on the selected context, in case a better match, which is not present in a general vocabulary (e.g., a name) may be found.

If the context is not broadenable (i.e., the broadest reasonable context has been examined), the process may return the results obtained as a “best guess” 421. If additional words or phrases remain 433, the process may continue.

If the context is broadenable, the process will broaden the context in a useful manner 419 (e.g., in the building 101 example, the context may be expanded from a single location context to a floor-level or building-level context) and will select a new vocabulary based on the broadened context. The process then repeats.

If a match is found, the process also determines if there are multiple matches within the context 423. For example, without limitation, two of three possible results may be found within the context. Or, in another example, a new word within the context vocabulary may return a phonetic match, and a previously identified word may also be identified within the context vocabulary. In this instance, the process may determine if the context is narrowable 427 (e.g., in the building 101 example, if the process began with a building-level context, it may narrow to a floor-level or location-specific context).

If the context is not narrowable, the process may return the multiple matches as a “best guess” 429. At a minimum, this may have possibly eliminated one or more of the initially identified words or phrases not present in the currently selected context vocabulary. If the context is narrowable 427, the process will narrow the context 431 and select a vocabulary associated with the narrowed context. The process may then repeat.

As can be seen from these examples, the use of a context based vocabulary can be used at any point in a process to further refine results, as is determined to be suitable by the process implementer. Through judicious application of the illustrative embodiments, both greater speed and accuracy of results can be obtained. In other instances, speed can be foregone for accuracy, or vice versa, but generally in any instance more favorable results from at least one perspective may be obtained.

FIG. 5 shows an illustrative process for context-related vocabulary updates. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a simplified speech evaluation based on context is presented. The process receives voice input 501 and sends a request for a translation into text 503. Also, in this example, the process may send any related context information deemed to be useful or relevant 505. For example, if location based context is utilized, and the recognition process is done on a remote server, the device may pass location information to the remote server for use in identifying the appropriate location-based vocabulary. Some information may be known or obtainable by the server itself (e.g., without limitation, time of day, day of week, etc.), but other information may be gathered and presented by the process running, for example, on a local device.

A response to the translation request is received 507 (e.g., once any suitable refinement has been performed) and is presented to the user for verification 509. If no errors are identified 511, the process sends a positive update to a context evaluation server 513 (or updates a locally stored vocabulary favorably). If there were errors in the response, a further search (possibly with an expanded vocabulary if no likely matches remain, or a narrowed vocabulary if too many likely matches exist) can be performed 515.

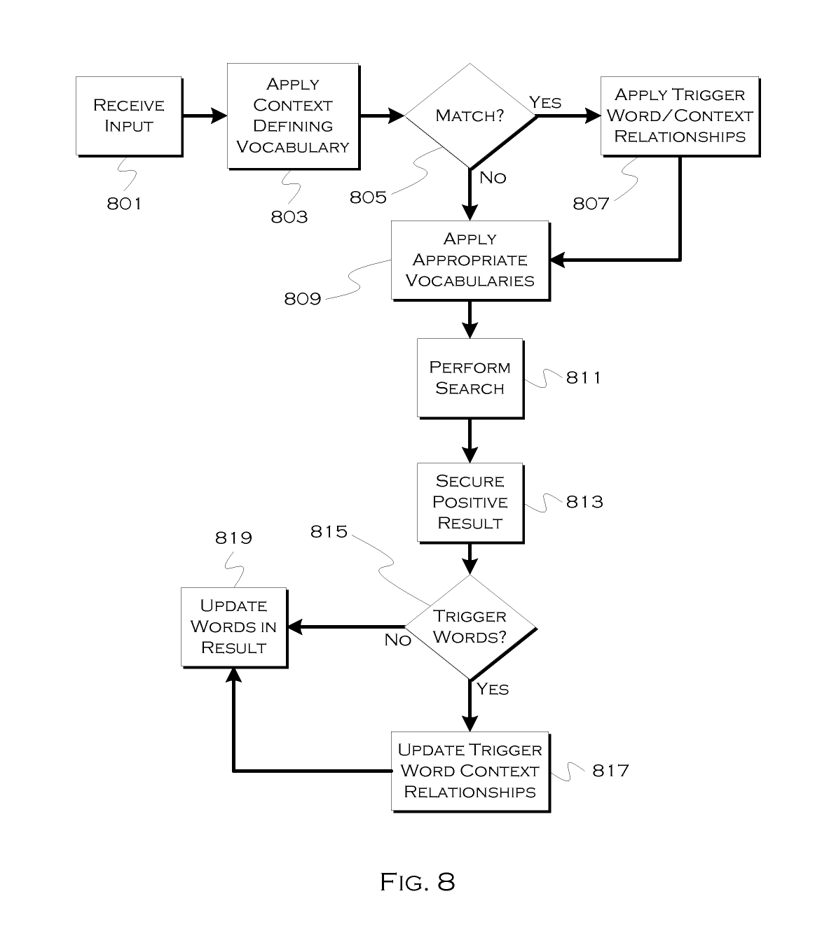

Updates, in this example, relate to the use of the word as observed by the accuracy of results. If one or more contexts was utilized in determining a vocabulary, once the results have been identified as accurate, the resulting word, words or phrase(s) can be added to the particular context or updated within the context. FIG. 7 provides an illustrative example of a context-vocabulary update process.

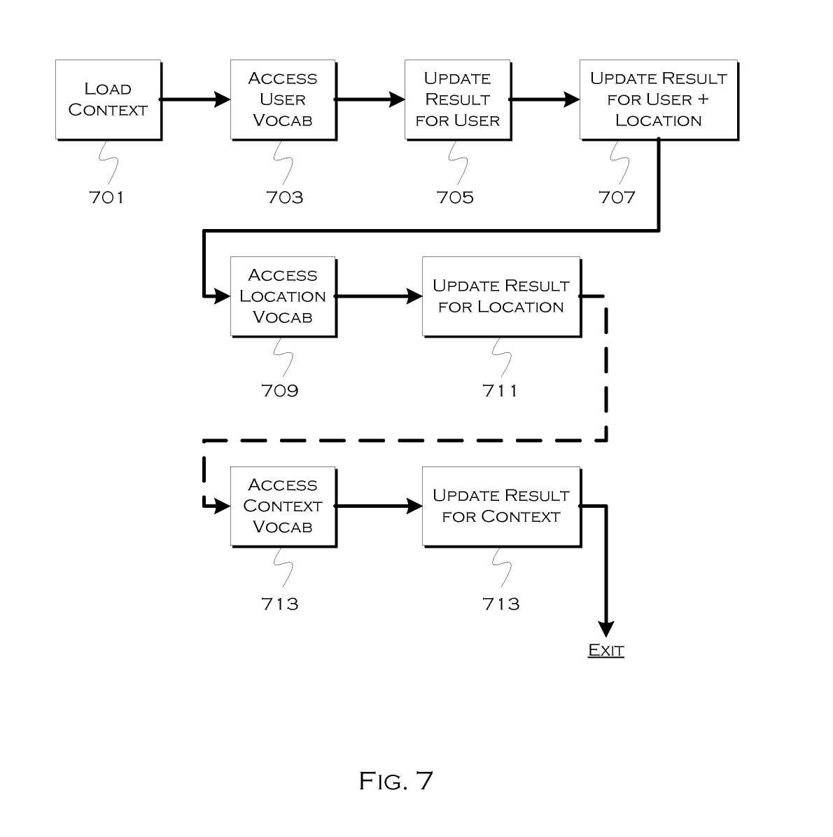

FIG. 6 shows another illustrative process for vocabulary updates. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a translation of speech input is sent to a user 601. The user is asked to respond 603 to confirm 605 the input, and/or performs an action (e.g., sending a text message) that effectively confirms the input 605. Alternatively, the user may edit the input, which means that some facet of the input was incorrect 605. The process may branch at 605, taking the “y” route for unedited words and the “n” route for edited words.

For words that were incorrect, the process instructs exclusion of these words from future results 615 related to this search and attempts a search again 617. Thus, the user could merely tap incorrect words on a device, and those words would be excluded from another search. Alternatively, not shown, the user could manually edit the incorrect words.

With respect to the correct words and any edited results representing the intended words, relevant words may be updated in the appropriate contexts 607. Each meaningful word, or each word, can be selected 609 and the relevant contexts (e.g., those used to define the vocabulary) can be determined 611. In this model, the process uses a version of the exemplary word:context model previously described. In a manner that positively augments the inclusion or continued inclusion of the word in the context vocabulary, the process updates the word:context association 613 or performs a similar reinforcing step.

In one example, vocabularies for given contexts may be predefined, but may also be subject to amendment based on observed user behavior. In such an example, the process may update each instance of the word in each vocabulary in a meaningful manner, such that the presence of the word is reinforced. In another example, a process may instantaneously or at periodic intervals rebuild a vocabulary based on word:context associations in a database. In this case, the word:context association is positively reinforced so the context vocabulary building process may look more favorably on inclusion of the word with respect to the context vocabulary. Other suitable methods for determining the dynamic addition, maintenance and removal of words from context vocabularies are also within the scope of this invention.

FIG. 7 shows yet another illustrative process for vocabulary updates. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process is shown updating varied vocabularies. In this example, the vocabularies are predefined, and are updateable based on results. Further, as context may have been iteratively expanded or contracted during the search, the context constraints used to determine each word are utilized in the update process.

After the context has been determined and utilized as needed for the search 701, the process loads a user vocabulary 703. In at least one example, all words used are candidates for inclusion in a user-vocabulary. Inclusion may be based on the same constraints as for other contexts, or, for example, may be based on varied constraints. Since a given user will likely provide a much smaller sample size than, for example, a location having thousands of users present thereat, the threshold for inclusion may be lowered accordingly. On the other hand, a system implementer may wish the user vocabulary to only include words very commonly used by a user, so the threshold may actually be higher than for a general location.

For each appropriate word for each vocabulary 703, 709, 713, the process will update the results in a positively reinforcing manner 705, 707, 711, 715. In the example, updates are applied to user vocabularies 705, user+location vocabularies 707, location vocabularies 711 and any other suitable context vocabularies 715.

It is also possible, that with respect to any given vocabulary, incorrect results are updated in a negative manner. For example, in one model, a word that repeatedly is rejected as incorrect may be removed, regardless of decay. In order to optimize accuracy, for example, the successful results of the word can be compared against the false positives, and a word that demonstrates sufficient false positives may be removed, even if it otherwise meets a usage threshold. Since the word is potentially still available in a broader vocabulary, the word is not gone entirely, but has been removed from the more specific vocabulary due to repeated confusion caused by its presence.

For example, without limitation, assume that with respect to the building 101 example, a user asks “where is chemistry professor McFresson's organic chemistry class?” while standing at location 125c. In this example, the location-based vocabulary used is illustratively based on a combination of building 101 vocabulary (including, in this example, chemistry department vocabulary and English department vocabulary) and location 125c vocabulary.

After a search within the context vocabulary, a proposed translation of “Where is chemistry professor's McPherson's organic chemistry class?” is returned (there is no professor McFresson, in this example, but “McPherson” returns a suitable match, given the context and the fact that the phrase “professor McPherson” is the only remotely related match within the context vocabulary). The user then identifies this as the intended query.

In this example, the words “chemistry,” “class,” and “organic,” are positively updated for each appropriate context as being utilized, if needed. In some contextual situations, it may be the case that a word can never be removed from an established base vocabulary without manual intervention. Thus, even if a word is not frequently utilized, it will remain a part of a vocabulary because it was identified as an appropriate member of the vocabulary set.

For the sake of the example, it will be assumed that the base vocabulary was established when no organic chemistry class was offered, and thus, in this example, the word “organic” was not included in the base vocabulary. But, in the years since, the class has been added and thus organic has worked its way into the vocabulary.

Initially, in this exemplary, non-limiting situation, the initial use of the word “organic” is insufficient to add the word to the vocabulary, but the word can be added through an observed pattern of utilization. Each time the word is used, usage can be tracked and once usage achieves a desired threshold, the word can be added. It is noted that any number of different paradigms can be used to establish the appropriateness of addition of a word to a vocabulary. Some non-exhaustive examples include: total usage above threshold, total usage above threshold within a time period, total usage minus decay above threshold, usage of a word added to a generic form of a context vocabulary, etc.

In one total usage above threshold non-limiting example, a word merely has a counter associated therewith, with respect to a context, and once the counter passes a threshold for usage within that context, the word is added. If no decay is included, once a word is added, usage for that word can cease being tracked.

So, for example, if a server stored vocabularies for building 101, the chemistry department, the English department and location 125c, this may be the twentieth usage of the word in the building (thus applying to the English and the chemistry department), but only the third usage of the word at location 125c (because, for example, the class is on a different floor). If the threshold was twenty usages, then the word would be added to the vocabularies of building 101, the chemistry department and the English department, but not yet added to the specific vocabulary of location 125c.

In such an example, the recognition process will have had to go outside the context vocabulary to determine the word “organic,” but in future queries, the process will find the word within the context vocabulary as utilized in the example.

It may also be the case that there is no reason to add the word “organic” to the English department vocabulary. One non-limiting way of addressing this would be to add the word originally (since the autonomous system doesn't “know” that “organic” is a chemistry related word), and then, over time, higher frequencies of usage with respect to chemistry-only areas (e.g., without limitation, a chemistry classroom) might identify the word as a candidate for removal with respect to the English department vocabulary. Other suitable methods of blocking the word initially or later removal of the word may also be used. Or the system administrator may simply not care, since both departments have classes in the same building, and unless the vocabularies grow to a point where their usefulness is limited, there may be no need to remove the occasional unneeded word. In another example, all the other words in the request may have been found only or primarily in the chemistry vocabulary, so the “unknown” word “organic” may be updated only with respect to the chemistry vocabulary. In still another non-limiting example, there may be some commonality of words in the request between a number of utilized vocabularies, but any unique words appearing in only one of the vocabularies all appear with respect to the same one vocabulary (in this case, the chemistry vocabulary) and on that basis the process updates the usage of the word “organic” with respect to the same one vocabulary only (e.g., the chemistry vocabulary here).

In another example, the process may use simple decay to determine if a word was used enough times within a suitable time period. For example, the time period may be set to “one month,” and the process may remove instances of the word used more than one month past, as a basis for determining the threshold. In this example, the word could remain once added, or, for example, could be removed if the usage ever fell below the required threshold (and could subsequently be re-added, etc.).

In yet another example, more advance decay techniques can be used as appropriate for a given situation. Decay can also be disabled, for example, in order to account for down-time (such as summer in the school context). In still a further non-limiting example, a single instance of a word can result in inclusion. In this example, a generic vocabulary (such as one not specifically associated with the location, but usable by a multitude of users at varied locations to establish base vocabularies) can be checked to see if the utilized word is included in the common, generic vocabulary. For example, a generic “chemistry department” vocabulary and a generic “English department” vocabulary could be checked, and it could be discovered that “organic” resides within the generic chemistry department vocabulary. The word could accordingly be added to the chemistry department vocabulary with respect to building 101 (or the chemistry department vocabulary for the university, for example, if a broader university-wide chemistry department vocabulary is utilized in the appropriate building(s)). Decay can be triggered at appropriate intervals, including, but not limited to, continuous, formulaic decay, decay upon input of any word, periodic decay at fixed intervals, etc.

Words in the query such as “where” and “is” may be ignored for addition/subtraction to vocabularies, given their high frequency in almost any context. But, they may be useful in defining the context vocabulary to be used. For example, the use of “where is” may trigger the inclusion of a building vocabulary, because the querent likely needs a location within the building. A combination of contexts and words may also be used to determine the constraints on the vocabulary. For example, a location (here, in the building 101) and the use of “where is” may cause inclusion of the building vocabulary (because it is likely directions within the building may be needed). In another example, the use of “what is” and the location “classroom” may cause inclusion of a subject matter vocabulary related to a class ongoing in that classroom (because the query is likely directed at obtaining an answer to an informative question about the subject).

At the same time, the use of “where is” in the location “classroom” would not necessarily include the subject matter vocabulary, if the system guesses that the student needs directions (because the subject matter vocabulary does not include direction/location related words, in this example). This type of context assembling process can also learn based on crowd sourcing, however, and repeated queries of “where is X element found on earth” may eventually trigger the addition of a subject matter vocabulary (chemistry), based on “where is” and the location “classroom,” since the process may repeatedly have to check outside of a building vocabulary (since the names of elements, the word “element” and the word “earth” are probably not in a building vocabulary), to find the appropriate result. Alternatively, the building vocabulary may eventually adapt to include the appropriate terms, solving the problem in that manner.

If the building vocabulary adapted to include terms such as element names, “element,” and “earth,” this is not necessarily a problem. Because the vocabularies can adapt to usages at their locations, if each location has its own vocabulary associated therewith, inclusion of words that are outside the original realm of the vocabulary name is not a problem. On the other hand, if the same “building” vocabulary were used across five thousand different buildings, drawn from and stored at a common source, it may be desirable to limit the addition of words to those related to buildings, in order to prevent overpopulation of the vocabulary through nuanced word usage at five thousand different sites. This can be done, for example, without limitation, by significantly increasing thresholds for inclusion, such that words used at many of the five thousand sites would still likely meet the threshold, but site-specific words probably would not.

FIG. 8 shows an illustrative vocabulary search and update process, wherein a set of “trigger” words are used to refine vocabulary selection. As previously noted, in at least some embodiments, so called “common” words are exempted from individual vocabularies, due to their commonality across such a wide variety of contextual situations. These can include, for example, without limitation, words such as “a” or “the,” query words such as “who,” “what,” “where,” “when,” “how,” “why,” forms of “to be,” and any other suitable words that don't necessarily relate to the subject matter of a vocabulary.

While perhaps not vocabulary-related, many of these “common” words can be used to select vocabularies. For example, queries including “where” will frequently relate to vocabularies including location-type information. Queries including “what” may relate to vocabularies including informative-type information. “Who” queries might include vocabularies of staff/personnel type information.

As with other aspects of the illustrative embodiments, the meanings of the vocabularies can shift over time. For example, if a full set of vocabularies for a building included: “chemistry department,” “building,” “facilities,” “lab” and “chemistry,” then, for that location, queries including “who” might first utilize a “chemistry department” vocabulary. Over time, however, a sufficient number of inquires about relevant chemists might cause the use of “who” to further initially include the “chemistry” vocabulary in a search list.

Thus, if the building had a “trigger word” vocabulary associated therewith, this could be initially configured based on the available building vocabularies. Over time, the trigger vocabulary could be dynamically changed through observed behavior to include (or exclude through decay) other vocabularies. In a similar manner to that of how words are associated or disassociated with individual vocabularies, whole vocabularies associations could be updated to be added or removed from relationships to trigger words.

In this example, the process receives an input 801. Using the previous example of “where is chemistry professor McFresson's organic chemistry class,” the process first utilizes a “trigger word” vocabulary to identify possible trigger words in the query 803. Here, the phrase “where is” appears in the trigger word vocabulary, and a match 805 is found for that portion of the question (thus also completing the translation for that portion). Based on the use of “where is,” the process then applies the appropriate vocabularies 807, which, in this example, include “building,” “facilities,” and “chemistry department.” Any other appropriate vocabularies may then also be included 809, based on, for example, the location of the user asking the question.

In this example, once the appropriate vocabulary has been assembled (if needed) from available vocabularies, the process can perform a search 811 to find the remaining words in the input. This search may be iterative, as previously noted, expanding the vocabulary size based on previously un-included vocabularies affiliated with a location, before moving to a broader encompassing vocabulary, until all words are found with some tunable degree of confidence.

Once the result has been presented to the user and confirmed 813, the process will determine if any trigger words were used in the original input 815. In this case, the phrase “where is” was used, so the process may update the relationship of those trigger words to any vocabularies eventually used to complete the entire translation 817. For example, during an iterative translation and search process, the process may have had to include the “chemistry” vocabulary, in order to translate the word “organic,” to the originally selected vocabularies (“building,” “facilities,” and “chemistry department”), so an affiliation between “where is” and the “chemistry” vocabulary may be positively updated, as well as the affiliations between “where is” and the originally selected vocabularies. Decay of unused vocabularies can also be performed at this time, to decay the relationship between “where is” and any vocabularies not utilized in the eventual translation.

Word-associations are also updated 819 in this example. This can result in a sort of digital foot-race. If the affiliation between “where is” and the “chemistry” vocabulary is reinforced a sufficient number of times, future use of “where is” may result in inclusion of the “chemistry” vocabulary for this location. But, at the same time, the word “organic” may be reinforced with respect to the “building,” “facilities” and “chemistry department” vocabularies (or some subset thereof). If the word “organic” is added to any of those vocabularies prior to the association between “where is” and “chemistry” reaching the inclusion threshold, then future requests of “where is chemistry professor McFresson's organic chemistry class” will not need the “chemistry” vocabulary to be translated, because “organic” will exist in one or more of the “building,” “facility,” and “chemistry department” vocabularies added on the basis of the word “where is.” This will result in decay in the relationship between “where is” and the “chemistry” vocabulary, because that vocabulary will no longer be needed to complete the translation.

In this example, since there is a base set of vocabularies utilized with respect to “where is,” the relationship between the trigger phrase and those vocabularies will not decay, because those vocabularies are always used to translate the question including “where is.” Similarly, once a vocabulary has reached a threshold for inclusion with respect to the trigger word, that vocabulary will persist, for the same reason. If this effect is not desired, accommodation can be made such that in any “where is” query, for example, positive reinforcement can be made only with respect to vocabularies from which the actual translation is drawn (i.e., cross reference the final translation with the individual component vocabularies from the utilize translation vocabulary and only reinforce those containing words in the final translation). Of course, certain vocabularies can also be designated as “always include” or “always exclude” (from the set selected based on the trigger word/phrase) as well.

It is worth noting that, in the simplest of examples, a single vocabulary for a location may be assembled for any query at that location using all vocabularies associated with that location. Use of trigger words could be used to limit this vocabulary to sub-vocabularies that make up portions of the larger vocabulary, but in either event the total number of words searched will likely be significantly lower than the total number of possible matches in the entire language set.

The location vocabulary may be assembled first based on an administrator's choices of which vocabularies to include, which can be done, for example, without limitation, on a per-location basis, for an entire site including a plurality of locations, or according to an algorithm based on a location type identified by cross-referencing a location with data usable to determine one or more location characteristics. Several non-limiting examples of this will be given below.

In the first example, a system administrator designates all the vocabularies for use at a building (which can include a set of specific locations), a site (e.g., an outside set of locations), or on a per-location basis. Other groupings of individual locations are also possible. These vocabularies are then used to build an initial whole vocabulary for that location/building/site/etc., which is stored with respect to that location/building/site/etc. One example of this is provided earlier herein with respect to the curator-museum illustration.

With time, usage of words outside this vocabulary will result in the inclusion of those words in the stored vocabulary, thus refining the stored vocabulary. Each query at the building, for example, will use the whole vocabulary for the building, and no distinction between the component vocabularies is needed. While this may result in slightly larger vocabularies than ones assembled dynamically, the whole vocabulary should still be significantly smaller than an all-possible-words type vocabulary. Context is still used, in this example, but the context is largely the presence of the user at the building/site/location.

In a second example, the administrator designates all the vocabularies for use at the building/site/location, and then on a query-by-query basis, for example, vocabularies are dynamically assembled as needed from those related to the location. In this example, some amount of time is needed for dynamic assembly, but this allows words to be selectively added to only those vocabularies used to respond to a specific query. Smaller translation vocabularies (dynamically assembled from the component vocabularies) may result in faster or more accurate results, and so the tradeoff between vocabulary assembly time vs. faster/more accurate response time can be considered when choosing a paradigm. The individual component vocabularies can still adapt based on usage, so location-related vocabularies should grow in terms of relevant word/phrase inclusion.

In a third example, a model or algorithm defines which base vocabularies (drawn, for example, from a vocabulary repository) should be affiliated with a given location. For example, without limitation, a building identifiable through a building name or address as a “general studies” building may draw a set of vocabularies related to “general studies” based on some universal or broader than site-specific model. Applying these as the core vocabularies, the paradigms of the first or second examples above could then be used. In this case, even the models themselves could be updated to reflect (based on observed individual site usage) which vocabularies “actually belong” in a “general studies building” model.

All of these examples are for illustrative purposes only, to show the adaptive nature of the illustrative embodiments and to show some non-limiting instances of how these embodiments can be applied. Many suitable paradigms for initial-usage, updating and vocabulary assembly and utilization can also be used in conjunction with the illustrative embodiments. If adaptive vocabularies or other associations were discovered to be growing too quickly to remain useful, the thresholds for inclusion could be varied, or the adaptiveness could be removed entirely, to fix a vocabulary to a set of prescribed words. Even a fixed vocabulary for a location would likely include a large number of words and phrases utilized at that location (assuming the vocabulary was properly expansive and relevant) and could improve search speed or accuracy (or both).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive speech-input;
receive at least one location-identification;
determine a location-related context based on the location-identification;
access a context-related vocabulary based on the location-related context;
search for word matches from the speech-input in the context-related vocabulary; and
provide match candidates found within the context-related vocabulary as translation of some or all of the speech-input into text.

2. The system of claim 1, wherein the location-identification is received from a device broadcasting a static location identifier.

3. The system of claim 2, wherein the static location identifier is wirelessly relayed through a mobile device, at which the speech-input was input, to the processor, and wherein the processor is configured to use the static location identifier to determine the location of the mobile device.

4. The system of claim 1, wherein the location-identification is based on a broadcast coordinate system.

5. The system of claim 1, wherein the context includes a site characteristic proximate to a location identified by the location-identification.

6. The system of claim 5, wherein the site characteristic includes a physical building characteristic.

7. The system of claim 6, wherein the physical building characteristic includes a building resource.

8. The system of claim 6, wherein the physical building characteristic includes a room type.

9. The system of claim 6, wherein the physical building characteristic includes building personnel offices.

10. The system of claim 6, wherein the physical building characteristic includes a building purpose.

11. The system of claim 1, wherein the context includes a temporary site characteristic proximate to a location identified by the location-identification.

12. The system of claim 11, wherein the temporary site characteristic includes a mobile location including a mobile location-identification providing device.

13. The system of claim 11, wherein the temporary site characteristic includes characteristics associated with the location for a scheduled period of time.

14. The system of claim 5, wherein the site characteristic includes a point of interest characteristic related to a point of interest proximate to a location identified by the location-identification.

15. A system comprising:
a processor configured to:
receive a request from a mobile device to translate speech-input into text;
receive a location-identifier from the mobile device;
determine one or more location-related contexts associated with the location-identifier, each context having a vocabulary of context-related words associated therewith;
translate the speech-input into text;
update usage of words in the speech-input with respect to the vocabularies of the determined location-related contexts; and
if a word usage passes a predetermined threshold, based on aggregated updates to an associated usage tracking factor, based on requests from users inputting speech to be translated into text at a location associated with the location-identifier, adding the word to at least one of the vocabularies in which the word does not currently exist.

16. The system of claim 15, wherein the word is added to all vocabularies of the determined location-related contexts in which the word does not exist.

17. The system of claim 15, wherein the processor is configured to periodically update the usage of words in a decaying manner, such that words that have not been used within a threshold period of time have the associated usage tracking factor moved further from the predetermined threshold.

18. The system of claim 15, wherein the processor is configured to determine an optimal vocabulary with respect to which the usage of a word not appearing in any of the vocabularies is to be updated, based on which vocabulary solely contains the greatest number of unique words in the speech-input, and to only update the usage of the word with respect to the determine optimal vocabulary.

19. A system comprising:
a processor configured to:
receive assignment of a plurality of context-identifiers associated with resources located proximate to a site, the assignment associating one or more context-identifiers with each resource, the resources and site being identifiable based on location-identifying information received in conjunction with a request to translate speech-input into text, wherein each context-identifier is associated with a vocabulary, including words related to the context;
receive a request to translate speech-input into text, including the location-identifying information;
determine one or more context-identifiers associated with a resource identifiable based on the location-identifying information;
utilize the vocabularies associated with the one or more context-identifiers to determine the contents of the speech-input; and
return the determined contents to an entity from which the request came as translated text based on the determined contents of the speech-input.

20. The system of claim 18, wherein the processor is further configured to:
update a usage factor associated with a word in the determined contents of the speech input, not present in the utilized vocabularies, such that the usage factor tracks the frequency of speech-input translation requests both including the word and associated with the resource; and
add the word to the utilized vocabularies if the usage factor exceeds a predetermined threshold.
